(19) United States
(12) Patent Application Publication
(10) Pub. No.: US 2007/0018483 A1
(43) Pub. Date: Jan. 25, 2007

(54) Motor vehicle having a roof

(75) Inventors: Martin Kerscher, Dornwang (DE); Josef Reindl, Karlsfeld (DE); Udo Haenle, Dachau (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/526,732

(22) Filed: Sep. 26, 2006

Related U.S. Application Data
(63) Continuation of application No. PCT/EP05/03017, filed on Mar. 22, 2005.

(30) Foreign Application Priority Data
Apr. 1, 2004 (DE) 10 2004 016 134.8

(51) Int. Cl. B60J 7/00

(52) U.S. Cl. 296/187.02

(57) ABSTRACT

Motor vehicles designed as station wagons having a large roof opening have a tendency toward body shaking. To minimize body shaking, at least one foam composite component is provided in the node region of a rear pillar and an additional body structural component. The foam composite component includes a base body which is coated in places with a foam material. As the result of heat treatment the foam material expands and fills the cavity in the node region in a manner which increases rigidity.

This application is a continuation of PCT/EP2005/003017, filed Mar. 22, 2005, and claims the priority of DE 10 2004 016 134.8, filed Apr. 1, 2004, the disclosures of which are expressly incorporated by reference herein.

### BACKGROUND AND SUMMARY OF THE INVENTION

The invention relates to a motor vehicle having a roof with an opening.

In vehicles, particularly passenger motor vehicles designed as station wagons, minivans, offroad vehicles, sport utility vehicles, sport activity vehicles, or the like, roof systems are possible which have a considerably larger roof opening compared to conventional sliding or tilting roofs. Such roof systems weaken the supporting roof structure and consequently reduce the overall rigidity of the vehicle body. Depending on the operating state of the vehicle, this causes “body shaking” which, for known vehicles having large roof openings, is minimized by means of reinforcements in the sheet metal structure of the body.

The object of the invention is to provide approaches by which body shaking may be minimized in vehicles having a roof opening so as to reduce costs and economize on weight.

The essential concept of the invention is to introduce in a targeted manner a foam composite component, composed of a base body and an external support made of a foam material, into the cavity in the region of a rear body pillar of the motor vehicle. The support covers at least a portion of the surface of the base body. The foam composite component is introduced into the region of the rear body pillar during manufacture of the body shell of the vehicle. As the result of subsequent heat treatment, preferably during painting of the body, the foam material expands and causes the foam composite component to fill, at least in places, the cavity in the region of the rear pillar. This results in a significant increase in the rigidity of the body in the rear area of the vehicle, along with a marked reduction in body shaking.

For the referenced types of vehicles, the foam composite components are inserted into the C-pillars and/or D-pillars in the lower, center, or upper section of the pillars. “Pillar” is understood to mean the entire body post, i.e., also the region of the pillar that continues below the top shoulder line of the vehicle. The foam composite components preferably are introduced symmetrically in the left and right halves of the vehicle body.

As a result of the invention, use is made of an existing cavity to reinforce the body without weight-increasing intervention in the sheet metal structure of the vehicle body. If additional modifications are made to the sheet metal structure, the extent of necessary measures therefor may be greatly reduced. Thus, considerable weight economy is realized by the invention.

To improve energy absorption in the event of collisions and to increase rigidity of the body, it is generally known from German patent publications DE 42 03 460 A1 and DE 198 12 288 C1 to introduce into a hollow profile of a motor vehicle body a foam composite component composed of a base body having an external layer made of a foam material, the base body being fixed in place in the cavity by means of a heat-activated foam process. However, it cannot be inferred from the prior art that, as the result of placing foam composite components in node regions in the rear pillars of vehicles having large roof openings, the problem of body shaking can be solved by using the foam composite components to reduce micromotions in the node regions.

Furthermore, foam composite components for filling body cavities are known from European Patent No. EP 0 697 956 B1. However, there is a fundamental difference in the known foam composite components compared to the foam composite components used according to the present invention, in that the foam composite components according to EP 0 697 956 B1 contain a foamable core that is bordered on the outside by a support. The support may be fixed in place in a body cavity, so that in the subsequent heat-activated foaming the foam material is able to expand into a defined region in the cavity. The foaming of body cavities using foam composite components according to EP 0 697 956 B1 primarily prevents the air column in the body cavity from being set in vibration. Due to the great foam thicknesses, the high foaming rate, and the low strength of the foam material, the known approach does not result in an appreciable increase in rigidity.

The foam composite component preferably is introduced into a node region of the rear pillar in order to achieve a particularly efficient reinforcement of the body structure. Depending on the design of the body structure, the foam composite component mainly fills only the node region, or also projects into the cavity in the rear pillar and/or at least into a cavity of an adjacent structural component.

In the context of the invention, “node region” is understood to mean the region in which the rear pillar adjoins an additional supporting component of the vehicle body.

According to another embodiment of the invention, a foam composite component is introduced into the cavity in the region of a rear pillar, the base body of the foam composite component being provided at least on one side with a heat-activatable foam material. In contrast to the inventive approach according to claim 1, the foam composite component does not fill the entire cavity or a predominant portion of the cavity in the region of the rear pillar, but, rather, is connected only to a partial region of the interior of the cavity. In this manner a very effective reinforcement of the body and minimization of body shaking is achieved, with low manufacturing costs and only a slight increase in weight.

It is known from U.S. Pat. No. 5,213,391 to connect a first structural component, having a flange bearing a foam material on the outside, to a second structural component, in that the cavity between the flange of the first structural component and the second structural component is filled by expansion of the foam material. This type of connection increases the rigidity of the body and also provides sound insulation. The known approach differs significantly from the present invention in its implementation, and furthermore proceeds from a totally different problem.

The base body preferably is composed of a plastic material which is economically manufactured in an injection molding or casting process and has a geometry that conforms to the cavity in the vehicle body. The base body advantageously is provided with ribbing to increase the rigidity while maintaining low weight and ease of manufacture. A fiberglass-reinforced plastic is preferably used.

The base body is designed in such a way that it fills the cavity at least in places after insertion therein. In this manner the strength and rigidity of the base body significantly affect the reinforcement that can be achieved for the rear pillar. For this reason the base body must be designed with appropriate stability with regard to its material and structure. The base body itself may be composed of solid material, be designed as a hollow body, have ribbing, be designed in one piece, be built from multiple components, etc.

The base body may also be composed of a metallic material, and designed as a metal sheet, extruded profile, cast component, or the like. In particular, sheet metal may be used in the invention according to claim 10.

Because the geometry of the base body conforms to the cavity, there is only a very small distance between the base body and the inner walls of the cavity. This small space between the base body and the inner walls is spanned by the foam material. The small layer thickness of the foam material allows the transmission of large pressure, tensile, and shear forces. The foam material thus provides an integral connection, having high load-bearing capacity, between the base body and the inner wall of the cavity, and therefore acts as an “adhesive material” which automatically and completely fills the space between the base body and the inner wall. In the heat-activated expansion, the foam material undergoes a comparatively small volume increase of 60 to 100%, for example. The foam materials used are “structural foams,” which in the expanded and hardened state have very high rigidity and are therefore able to reduce the micromotions of the structure, which are responsible for body shaking. In contrast, acoustic foams which are introduced to minimize sound propagation in body cavities do not result in appreciable reinforcement of the structure.

Other objects, advantages and novel features of the present invention will become apparent from the following detailed description of the invention when considered in conjunction with the accompanying drawings.

### BRIEF DESCRIPTION OF THE DRAWINGS

FIGS. 1a, 1b show perspective views of a body shell of a vehicle according to an embodiment of the invention, having foam composite components in the region of a C- and D-pillar, as seen from the back side or front side, respectively, of the vehicle;

FIG. 2 shows a view of the interior of the body from FIGS. 1a, 1b, as seen from the center of the vehicle;

FIG. 3 shows a perspective view of a foam composite component in accordance with an embodiment of the present invention for mounting in the region of the lower end section of the C-pillar of the motor vehicle;

FIG. 4 shows an illustration, corresponding to FIG. 3, of a foam composite component for mounting in the center region of the C-pillar;

FIGS. 5 and 6 show an illustration, corresponding to FIG. 3, of a foam composite component for mounting in the upper region of the C-pillar;

FIG. 7 shows an illustration, corresponding to FIG. 3, of a foam composite component for mounting in the upper region of the D-pillar; and

FIG. 8 shows an illustration, corresponding to FIG. 3, of a foam composite component having a base body made of sheet metal, for mounting in the lower region of the D-pillar.

### DETAILED DESCRIPTION

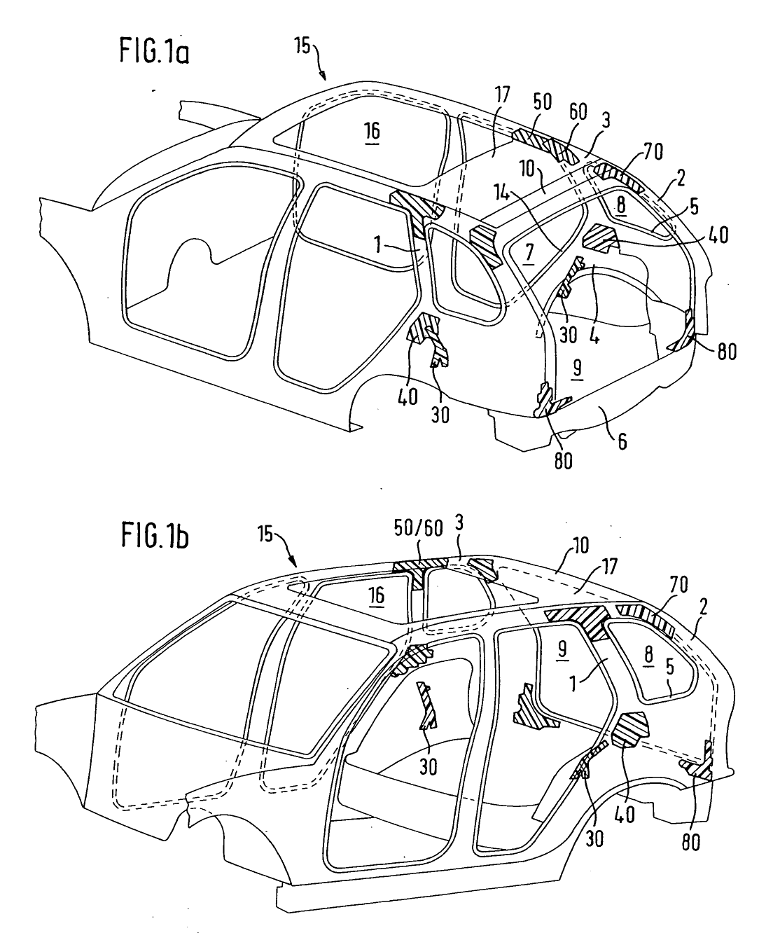

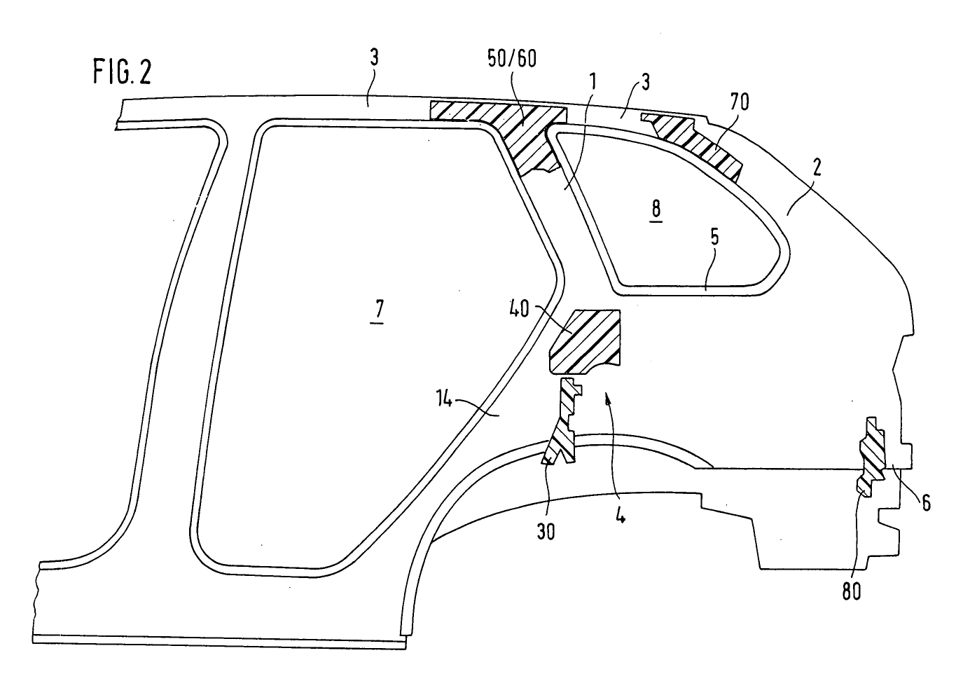

FIGS. 1a, 1b show a body shell of a vehicle in an overall perspective view, whereas in FIG. 2 only the rear region of the body side structure of the vehicle is illustrated. The vehicle is a sport utility vehicle having a C-pillar 1, a D-pillar 2, a lateral roof support beam 3, a rear inner side wall 4, a lower window hoop 5, a door boundary hoop 14, and a rear floor crossbeam 6. The referenced structural components 1 through 6 and 14 delimit a rear door aperture 7, a rear window aperture 8, and an aperture 9 for a trunk lid. On the rear side the lateral roof support beam 3 and a rear roof crossbeam 10 delimit a roof structure of a roof designated as a whole by reference numeral 15. The roof 15 has a large roof opening 16 which accommodates a large-surface movable roof element, such as a sliding roof cover, for example. Alternatively, the roof opening 16 may accommodate at least two movable roof elements. A stationary roof panel 17 adjoins the rear region of the roof opening 16.

Foam composite components 30, 40, 50, 60, 70, and 80 are situated in the region of the C-pillar 1 and the D-pillar 2, as illustrated in the overview illustrations of FIGS. 1a, 1b, and 2.

Each of the foam composite components 30 through 80 is composed of a base body 32, 42, 52, 62, 72, or 82, respectively. A comparatively thin support 33a and 33b, 43, 53a and 53b, 63a and 63b, 73a and 73b, or 83 made of a foam material is mounted, at least in places, on the outer surfaces of the respective base bodies 32 through 82.

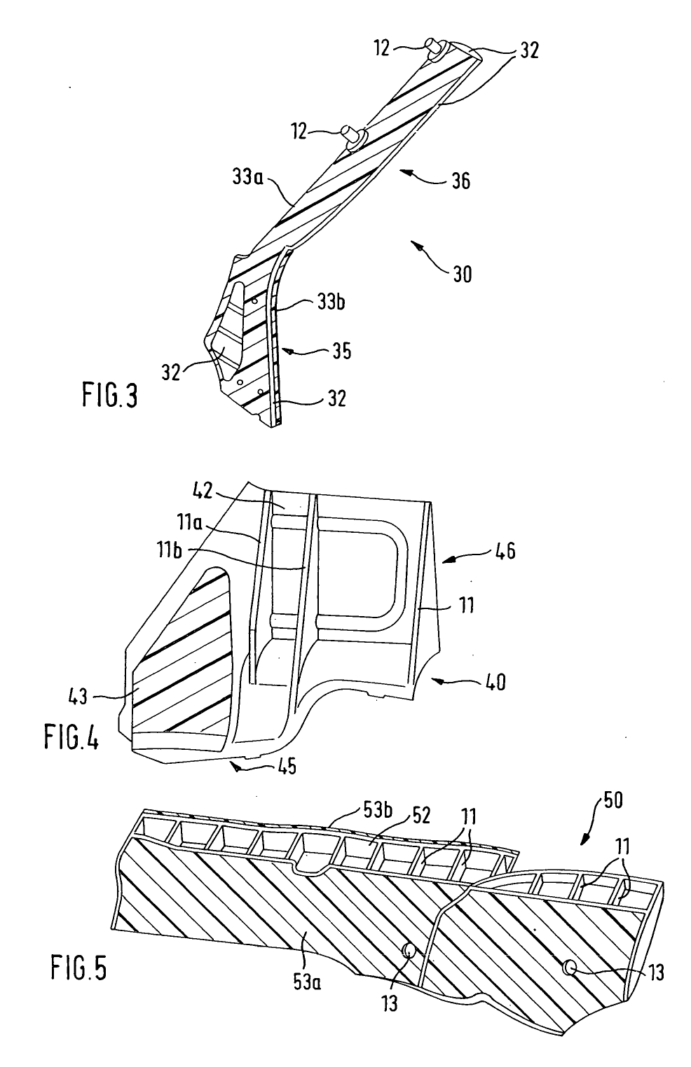

The base bodies 32 through 72 illustrated in FIGS. 3 through 7 are composed of a fiberglass-reinforced plastic material, and with the exception of base body 32 each have a plurality of ribs 11. Whereas the cavity to be filled by the foam composite component 30 is comparatively small (gap size approximately 10 to 15 mm) and the base body 32 may therefore designed as a solid material, base bodies 42 through 72 can be manufactured only as ribbed components. The supports 43, 53a and 53b, 63a and 63b, and 73a and 73b made of the foam material are each mounted in the region of the non-ribbed outer surfaces of the respective base bodies 42 through 72. The supports 53a and 53b, 63a and 63b, and 73a and 73b are located on opposite sides of the respective foam composite components 50, 60, or 70, so that after the foam material is expanded the foam composite components 50, 60, or 70 are supported on opposite sides of the particular body cavity, in a manner of speaking braced in the cavity by the expansion, thereby producing a particularly effective bracing of the cavity. As can be seen, for significant bracing of the body cavities it is sufficient to mount the supports 43, 53a and 53b, 63a and 63b, and 73a and 73b only on a portion of the outer surfaces of the respective foam composite components 40 through 70 so as not to completely cover the outer surfaces.

The same applies for the foam composite component 40, whereby the illustration according to FIG. 4 only shows the support 43 in the flat region of the “front side” of the foam composite component 40. A support made of foam material is likewise provided on the flat “back side,” not shown, of the foam composite component 40, situated opposite from the “front side” ribs 11a through 11c. Similarly, reinforcing ribbing is provided on the “back side” of the foam composite component 40, situated opposite from the “front side” support 43. In other words, the flat support regions for the foam material and the ribbing preferably are reciprocally provided on opposite “front and back sides” of the foam composite components.

All foam composite components 30 through 70 share the common feature of having supports 33a and 33b, 43, 53a and 53b, 63a and 63b, or 73a and 73b, respectively, which are attached to at least two different outer surfaces of the foam composite components 30 through 70. The supports 33a and 33b, 43, 53a and 53b, 63a and 63b, 73a and 73b preferably are located on oppositely situated outer surfaces of the respective foam composite components 30 through 70, as illustrated in FIGS. 3 through 7. In this manner, as previously described, an effective bracing of the cavity is provided by supporting the expanded foam material on oppositely situated inner walls of the cavity.

As an example, pin-like fastening devices 12 are illustrated on the base bodies 32, 62, and 72 by which the foam composite component 30 may be preliminarily placed on the body structure before ultimately being fixed in place after expansion of the foam material. Location holes 13 which engage with mounting pins on the body side (not shown) for positioning the foam composite component 50 are provided for the same purpose on the base body 52 of the foam composite component 50. In principle, the attachment may also be made using catch elements, hooks, etc.

The base body 82 of the foam composite component 80 is made of sheet metal, a support 83 composed of foam material being attached to only one side thereof.

The individual foam composite components 30 through 80 have different designs, corresponding to the different mounting sites.

Thus, the foam composite component 30 has an elongated base body 32, a first widened section 35 of which contacts the region of the inner side wall 4, and the upper section 36 of which extends into the pillar section of the C-pillar 1 adjacent to the side wall 4.

The foam composite component 40 fills the cavity present in the node region of the C-pillar 1 having the window hoop 5 and the door boundary hoop 14. Accordingly, the foam composite component 40 has an approximately L-shaped design with two wide, short legs 45 and 46 which are additionally connected to one another in a reinforcing manner by ribs 11a and 11b.

The foam composite components 50 and 60 are situated on the inside and outside, respectively, of the body shell, in the node region between the C-pillar 1 and the lateral roof support beam 3.

The oblong foam composite component 50 extends essentially only inside the lateral roof support beam 3, and thus in the installed position runs approximately in the longitudinal direction of the vehicle.

The T-shaped foam composite component 60, in contrast, is situated in the cavity between the outer sides of the lateral roof frame 3 and the C-pillar 1 on the one hand, and on an outer side wall (not illustrated) on the other hand. In this manner the leg 65 of the foam composite component 60, which is inclined slightly downward opposite the direction of travel, fills the cavity in the region of the C-pillar 1. In contrast, sections 66a and 66b of the foam composite component 60, which in the installed position run approximately horizontally, run along the lateral roof support beam 3, the longer section 66b being situated in the region behind the C-pillar 1 (relative to the direction of travel).

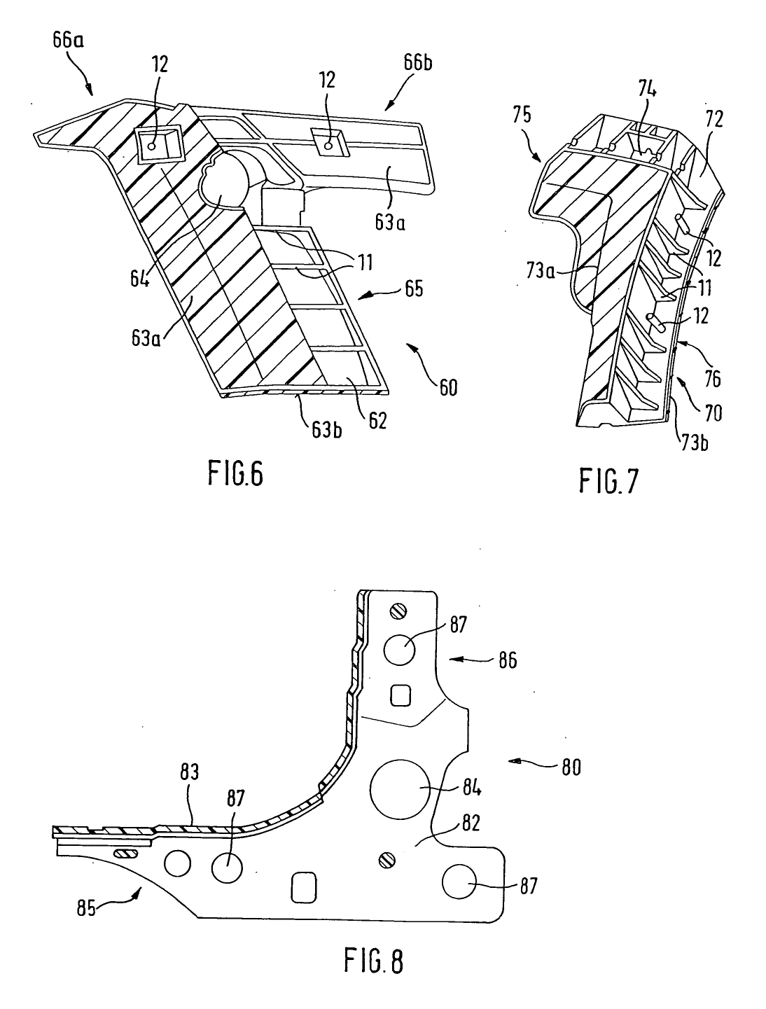

In a departure from the illustration in FIG. 6, the foam composite component 60 may also be designed without horizontally running sections 66a and 66b, depending on the requirements of the underlying body shell.

The opening 64 in the foam composite component 60 provides a space for an expansion nut (not shown) situated on the body. Similar openings 74 and 84 are provided on the respective foam composite components 70 and 80. In principle, the foam composite components 30 through 80 may be provided with one or more through openings for the following purposes, for example: attaching the foam composite component or adjacent components, providing installation spaces, ensuring inlet and outlet flow for cathodic dip painting, providing access for cavity sealing, etc.

The foam composite component 70 likewise has an approximate L shape, with a short, wide leg 75 projecting into the roof crossbeam 10 and a long leg 76 running in the direction of the D-pillar 2.

The design of the foam composite component 80 differs from that of foam composite components 30 through 70 in that it has a base body 82 made of deep-drawn sheet metal. In addition, it has an essentially planar structure, and its support 83 contacts only one side of the cavity without abutting the opposite wall of the cavity.

The foam composite component 80 has an L-shaped design, having a first leg 85 which in the installed position runs along the floor crossbeam 6, and a second leg 86 which extends in the direction of the D-pillar 2.

The unit composed of the foam composite component 80 and the floor crossbeam 6/D-pillar 2 represents a “sandwich component” having the material sequence metal-foam-metal. The foam composite component 80 is composed, for example, of sheet metal having a thickness of 2 mm and a foam material having a thickness from 5 to 6 mm.

The foam composite component 80 is introduced into the body shell of the vehicle as follows: The base body 82 has three circular recesses 87 which specify the distance of the base body 82 from the body shell, and therefore determine the width of the gap which is subsequently filled by the foam material. The position of the base body 82 in the other two spatial directions is set by two pins on the body side which engage with corresponding mounting openings 87 in the base body 82. To fix the target position of the base body 82 in place during foaming, the base body 82 is fastened via the recesses 87 to the body shell by spot welding.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle having a roof with an opening, comprising:
a vehicle body having a rear body pillar;
a foam composite component, including a base body with foam material located on an outside surface of the base body,
wherein
the foam composite component is located in a cavity in the vehicle in a region of the rear body pillar,
the foam material is expandable by application of heat, such that after heat-activated expansion the foam material at least partially fills a space between the base body and an inner wall of the cavity.

2. The motor vehicle according to claim 1, wherein
the foam material is located on at least two different outer surfaces of the foam composite component.

3. The motor vehicle according to claim 2, wherein
the foam material is located to at least two oppositely situated outer surfaces of the foam composite component.

4. The motor vehicle according to claim 1, wherein
the foam composite component is located a node region of a rear pillar and an additional structural component of the vehicle body.

5. The motor vehicle according to claim 4, wherein
the additional structural component is at least one of a lateral roof support beam, a side wall region, a window hoop, a roof crossbeam, a floor crossbeam, a door boundary hoop.

6. The motor vehicle according to claim 4, wherein
the foam composite component is sized to be limited primarily to the node region.

7. The motor vehicle according to claim 4, wherein
the foam composite component is an elongated component which extends over the node region into the cavity in the rear pillar.

8. The motor vehicle according to claim 5, wherein
the foam composite component is an elongated component which extends over the node region into a cavity of the additional structural component adjacent to the rear pillar.

9. The motor vehicle according to claim 8, wherein
the foam composite component is an approximately L-shaped or approximately T-shaped component which extends over the node region and into the cavity in the rear pillars as well as into the cavity in the additional structural component.

10. A motor vehicle having a roof with an opening, comprising:
a vehicle body having a rear body pillar;
a foam composite component, including a base body with foam material located on an outside surface of the base body,
wherein
the foam composite component is located in a cavity in the vehicle in a region of the rear body pillar,
the foam material is expandable by application of heat, such that after heat-activated expansion the foam material connects the base body to an inner wall of the cavity.

11. The motor vehicle according to claim 1, wherein
the base body is made of a plastic material.

12. The motor vehicle according to claim 11, wherein
the plastic material is a fiberglass-reinforced plastic material.

13. The motor vehicle according to claim 10, wherein
the base body is made of a plastic material.

14. The motor vehicle according to claim 13, wherein
the plastic material is a fiberglass-reinforced plastic material.

15. The motor vehicle according to claim 1, wherein
the base body has at least one reinforcing rib.

16. The motor vehicle according to claim 1, wherein
the base body is made of sheet metal.

17. The motor vehicle according to claim 10, wherein
the base body is made of sheet metal.

18. The motor vehicle according to claim 1, wherein
at least one fastening device is provided on the foam composite component for fastening the foam composite component to the vehicle body.

19. The motor vehicle according to claim 1, wherein
the roof opening accommodates a movable roof element or at least two movable roof elements.

20. The motor vehicle according to claim 1, wherein
the vehicle is one of a station wagon, a minivan, an off-road vehicle, a sport utility vehicle, and a sport activity vehicle.
